(19) United States
(12) Patent Application Publication
(10) Pub. No.: US 2008/0300225 A1
(43) Pub. Date: Dec. 4, 2008

(54) PESTICIDAL FORMULATION CONTAINING OXYMATRINE OR MATRINE

(75) Inventor: Pamela G. Marrone, Davis, CA (US)

Correspondence Address: CHERYL H AGRIS PHD, PO BOX 806, PELHAM, NY, 10803, US

(73) Assignee: Marrone Organic Innovations, Davis, CA (US)

(21) Appl. No.: 12/018,196

(22) Filed: Jan. 23, 2008

Related U.S. Application Data
(60) Provisional application No. 60/897,029, filed on Jan. 23, 2007.

(51) Int. Cl. A01N 43/40; A01N 43/42; A01N 45/00; A01P 7/04

(52) U.S. Cl. 514/171; 514/284; 514/277; 514/285

(57) ABSTRACT

Compositions and methods are provided for a water-soluble insecticidal or pesticidal comprising at least one alkaloid, particularly at least one tetracyclo-quinolizindine alkaloid derived from sophora roots, particularly matrine and/or oxymatrine.

### PRIORITY CLAIM

This application claims priority to provisional application No. 60/897,029, filed Jan. 24, 2007 under 35 USC § 119(e), the contents of which are incorporated herein by reference.

### FIELD OF THE INVENTION

This invention relates to compositions and methods for controlling pests using pesticides comprising alkaloids, particularly tetracyclo-quinolizindine alkaloids derived from sophora roots, particularly matrine or oxymatrine.

### BACKGROUND OF THE INVENTION

Insect pests can be the cause of a significant amount of physical and economic damage to crops around the world. In the past, conventional pesticides, such as organophosphates, DDT and carbamates have been used to treat these problems. However, these conventional chemicals carry health risks as well as pest resistance issues.

Safer pesticides have recently proven to be efficacious alternatives to conventional pesticides and have been coming into increasingly more favor, especially amidst the vigorous adoption of organic production methods by farmers over the past decade. Some of the broad areas of “safer” pesticides include, but are not limited to, microbes, plant extracts, food ingredients, etc.

Plants and plant derivatives have been used as agricultural insecticides for thousands of years, tracing back to ancient China, Egypt, India and Greece. (Thacker 2002. Documented use of these “natural” pesticides well predates the advent of synthetic pesticides. Pyrethrins are a class of insecticides derived from the pyrethrum daisy, Tanacetum cinerariaefolium, and are characterized by a rapid knockdown effect, particularly in flying insects, and hyperactivity and convulsions in most insects. There are many examples of plant extracts as insecticides, some of which are cited below.

The Indian Neem tree, Azadirachta indica, is another natural source of insecticides. Two classes of insecticides can be extracted from Neem. The first, Neem Oil, is effective against mites and soft-bodied insects. The second class can be extracted from the Neem Seed, and the most potent of these is the compound azadirachtin. Azadirachtin has been shown to have significant physiological effects on insects, blocking the release of molting hormones in immature insects, and causing sterility in adult females. Azadirachtin can also act as an anti-feedant in many insects. (Schmutterer 2002).

Azadirachtin is part of a larger group of chemicals known as Limonoids, compounds which are known to cause bitterness in citrus fruits. Several citrus limonoids and limonine derivatives have been found to have insect-controlling activities, serving as insecticidal toxins and feeding deterrents. These compounds can also kill insect larvae and disrupt reproduction. (Roy 2006).

Rotenone is also a well known insecticide and has been in use for over a century. It is produced in the roots of the tropical legumes Derris, Lonchocarpus, and Tephrosia. Rotenone disrupts the electron transport chain which is a vital step in the energy production of all living organisms. The compound must be ingested by the insect in order to take effect. (Hollingworth 1994).

Oxymatrine is a substance found in Sophora roots and has been used for many decades as a medicinal treatment for a variety of diseases such as fungal and parasitic infections, cancer, arrhythmias, skin problems and many others, and most recently for Hepatitis B and C (Kuizhi, Niu, 1997). The volume of current research in this area is intense. Although the medicinal properties of oxymatrine have been thoroughly evaluated, its ability to exhibit insecticidal activity has received very little attention by the research community.

Several processes for the preparation of oxymatrine are described in the literature, e.g., Chinese Pat. Nos. CN1148370C (C). Typically, oxymatrine is extracted from the root, leaf, stem or seed of sophora plants, which seems to be the easiest way to isolate the pure product.

The known marketed formulations contain between 0.5% and 2.0% oxymatrine or matrine. The authors of this invention used commercially available oxymatrine from Beijing Kingbo Biotech, Inc.

In U.S. Pat. No. 6,372,239, a cocktail of plant alkaloids is described; however, as it clearly appears said invention uses a combination of several plant alkaloids to exert its activity via multiple pathways, and thus is outside the scope of the present invention as will appear from the following.

The fact is that it has now surprisingly been found that a simple solution comprised of the active ingredients oxymatrine or matrine provides a highly effective insecticidal formulation that can be used against a variety of insect pests without having phytotoxic effects on the host plant or crop.

### SUMMARY OF THE INVENTION

Various studies have been directed towards assessing the effectiveness of oxymatrine and matrine to exhibit a pesticidal, particularly, an insecticidal effect. As a result of these studies, the present inventor has found that a solution containing primarily oxymatrine or matrine is an extremely effective formulation having the desired properties.

Thus, the invention is directed to a water soluble insecticidal formulation comprising at least one alkaloid, particularly at least one tetracyclo-quinolizindine alkaloid derived from sophora roots, particularly matrine and/or oxymatrine. The formulation may further comprise water wherein oxymaterine or matrine is present in the range of from about 0.1 to 20% by volume. In a particular embodiment, the formulation may further comprise a non-oxymatrine, matrine, anabasine, aloperine and/or toosendanin pesticide or insecticide. In yet another embodiment, the formulation is a water-soluble anabasine, aloperine and/or toosendanin free insecticidal or pesticidal formulation, comprising an insecticidally or pesticidally effective amount of oxymatrine and/or matrine.

The invention is further directed to a pest control method comprising treating an object with an amount of the formulations of the present invention effective to control pests on said object. The object may be a plant, fruit, building or other structures. The pest may be an insect or mite infestations.

### DETAILED DESCRIPTION OF THE INVENTION

Where a range of values is provided, it is understood that each intervening value, to the tenth of the unit of the lower limit unless the context clearly dictates otherwise, between the upper and lower limit of that range and any other stated or intervening value in that stated range is encompassed within the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

A formulation that meets the requirements described above can be economically prepared by a simple method which comprises mixing by mechanical means commercially available oxymatrine (or matrine) and water and/or other ingredients that are standard for insecticides, such as a surfactant, wetting agent (e.g., organosilicones, Silwet and Sylox), and/or dispersant. Examples of surfactants include, but are not limited to, polyoxyethylated alkylphenols (e.g., octylphenol and nonylphenol), polyoxyethylated sorbitan monoesters, polyoxyethylated fatty or aryl-alkyl alcohols, fatty acids and esters (e.g. TWEEN™ 40-80).

A brief description of the formulation of this invention will be given below. The formulation of the present invention comprises the following ingredients:

Oxymatrine and/or matrine. Water is also added; thus the formulation also comprises water. Furthermore, various water-soluble additives in the form of powders or granules may of course be added without changing the nature of the present invention.

The mention of the above products excludes in no way the use of other products with same effects according to this invention. Thus, the formulation may further comprise other biological or chemical pesticides except for anabasine, aloperine and/or toosendanin.

The amount of oxymatrine or matrine in the formulation of the invention may be widely varied, and will typically be from about 0.1% to about 20% by volume. The preferred concentration will be from about 0.5% to about 2.0%.

The amount of formulation to be used per hectare depends on the nature of the plant, the microclimate and the intended degree of efficacy. Normally the rate will vary between 0.5 to 2 liters/hectare.

### EXAMPLES

The following Examples demonstrate the efficacy of a 0.6% formulation according to the present invention. The tests have been carried out in eight different test systems:

### Test System 1—Efficacy Screen—Aphid

Procedure: Test plants, Chrysanthemum vestitum stapf, were planted into 1-quart containers in a growing medium consisting of 35% peat, 45% aged pine bark, 15% aged rice hulls and 5% composted hardwood. No pesticides were applied to test plants prior to study application. One plant equals one replicate. Test plants were placed in Zone 1 of research greenhouse on a wire-mesh raised bench and arranged in a randomized complete block design. Research greenhouse is monitored by Procom, Micro-Grow Greenhouse System temperature control system. Environmental conditions averaged high temperature 87 F to low temperature of 72 F during study dates. Average humidity levels ranged form 40% to 95%. Test plants received natural lighting for duration of study. Test plants were watered every twenty-four (24) hours as needed with a hand-held sprinkler. Plants were evaluated prior to application (precount), 2 days (48 hours) and 7 days after application. Four (4) leaves were randomly selected and harvested on each replicate. Actual count was recorded on live and dead aphid, Myzus persicae. Plants were evaluated for phytotoxicity on same rating schedule as above. Visual ratings were taken and recorded as percent of damage (0 to 100%) to whole plant as compared to control check.

Treatment: Treatment #1—Sample A 0.6% oxymatrine @ 1 ml/800 ml, and Treatment #2—Untreated Check.

Evaluations of Green Peach Aphid at 7 days after chemical application did show a significant decrease in the number of live aphid in Treatment #1, Sample A as compared to number of live aphid in Treatment #2, Untreated Check. There was no phytotoxicity on any treated plant. Results are shown in Table I.

TABLE I

| Insect | Green Peach Aphid/Myzus Persicae | | | | | |
|---|---|---|---|---|---|---|
| Crop | Chrysanthemum/Chrysanthemum Vestitum Stapf | | | | | |
| Part Rated | Pest | | | | | |
| Rating Data Type | Insect Count | | | | | |
| Rating Date | Day 0 | Day 2 | Day 7 | Day 0 | Day 2 | Day 7 |
| Insect Stage | LIVE | LIVE | LIVE | DEAD | DEAD | DEAD |
| Trt-Eval | PRECOUNT | 48 | 7 DA-A | PRECOUNT | 48 | 7 DA-A |
| Interval | | HOURS | | | HOURS | |
| MEAN COUNTS | | | | | | |
| Sample A | 35 | 32.5 | 5.75 | 0.5 | 10.75 | 23.25 |
| Untreated Check | 34.75 | 52 | 66.75 | 0.5 | 0.25 | 0.5 |

### Test System 2—Efficacy Screen—Two-Spotted Spidermite

Objective: Efficacy screen of SAMPLE A against two-spotted spidermite on marigold.

Procedure: Test plants, Marigold, Tagetes erecta l., were planted into 1-quart containers in a growing medium consisting of 35% peat, 45% aged pine bark, 15% aged rice hulls and 5% composted hardwood. No pesticides were applied to test plants prior to study application. One plant equals one replicate. Test plants were placed in Zone 1 of research greenhouse on a wire-mesh raised bench and arranged in a randomized complete block design. Research greenhouse is monitored by Procom, Micro-Grow Greenhouse System temperature control system. Environmental conditions averaged high temperature 87 F to low temperature of 72 F during study dates. Average humidity levels ranged form 40% to 95%. Test plants received natural lighting for duration of study. Test plants were watered every twenty-four (24) hours as needed utilizing a flood floor irrigation system. Plants were evaluated prior to application (precount), 2 days (48 hours) and 7 days after application. Three (3) leaves were randomly selected and harvested on each replicate. Actual count was recorded on live and dead two-spotted spidermite, Tetranychus urticae. Plants were evaluated for phytotoxicity on same rating schedule as above. Visual ratings were taken and recorded as percent of damage (0 to 100%) to whole plant as compared to control check.

Treatment: Treatment #1—Sample A 0.6% oxymatrine @ 1 ml/800 ml, and Treatment #2—Untreated Check. Spray application was made on 3 Oct. 2006 at 4:30 pm; 85.6 temperature; 68.0% humidity.

Conclusion: Evaluations of Two-spotted Spidermite at 7 days after chemical application did show a significant decrease in the number of live spidermite in Treatment #1, Sample A, as compared to number of live spidermite in Treatment #2, Untreated Check. There was no phytotoxicity on any treated plant.

TABLE II

| Insect | Two-Spotted Spidermite/Tetranychus Urticae | | | | | |
|---|---|---|---|---|---|---|
| Crop | Marigold/Tagetes Erecta L. | | | | | |
| Part Rated | Pest | | | | | |
| Rating Data Type | Insect Count | | | | | |
| Rating Date | Day 0 | Day 0 | Day 2 | Day 2 | Day 7 | Day 7 |
| Insect Stage | LIVE | DEAD | LIVE | DEAD | LIVE | DEAD |
| Trt-Eval Interval | PRECOUNT | PRECOUNT | 2 DA-A | 2 DA-A | 7 DA-A | 7 DA-A |
| MEAN COUNTS | | | | | | |
| Sample A | 61 | 0.5 | 76.75 | 47.75 | 53.25 | 147 |
| Untreated Check | 59.75 | 3.25 | 92.25 | 1 | 133.25 | 17 |

### Test System 3—Efficacy Screen—Western Flower Thrips

Objective: Efficacy screen of SAMPLE A against western flower thrips on marigold.

Procedure: Test plants, Marigold, Tagetes erecta l., were planted into 1-quart containers in a growing medium consisting of 35% peat, 45% aged pine bark, 15% aged rice hulls and 5% composted hardwood. No pesticides were applied to test plants prior to study application. Three (3) plants equal one replicate. Test plants were placed in Zone 1 of research greenhouse on a wire-mesh raised bench and arranged in a randomized complete block design. Research greenhouse is monitored by Procom, Micro-Grow Greenhouse System temperature control system. Environmental conditions averaged high temperature 85 F to low temperature of 70 F during study dates. Average humidity levels ranged form 45% to 100%. Test plants received natural lighting for duration of study. Test plants were watered every twenty-four (24) hours as needed utilizing a flood floor irrigation system. Plants were evaluated prior to application (precount), 2 days (48 hours) and 7 days after application. Three (3) leaves and two (2) blooms were randomly selected and harvested on each replicate. Actual count was recorded on live and dead western flower thrips, Frankliniella occidentalis. Plants were evaluated for phytotoxicity on same rating schedule as above. Visual ratings were taken and recorded as percent of damage (0 to 100%) to whole plant as compared to control check.

Treatment: Treatment #1—Sample A 0.6% oxymatrine @ 1 ml/800 ml, and Treatment #2—Untreated Check. Spray application was made.

Conclusion: Evaluations of Western Flower Thrips at 7 days after chemical application did show a significant decrease in the number of live thrips in Treatment #1, Sample A, as compared to Untreated Check. There was no phytotoxicity on any treated plant.

TABLE III

| Insect | Western Flower Thrips/Frankliniella Occidentalis | | | | | |
|---|---|---|---|---|---|---|
| Crop | Marigold/Tagetes Erecta L. | | | | | |
| Part Rated | Pest | | | | | |
| Rating Data Type | Insect Count | | | | | |
| Rating Date | Day 0 | Day 0 | Day 2 | Day 2 | Day 7 | Day 7 |
| Insect Stage | LIVE | DEAD | LIVE | DEAD | LIVE | DEAD |
| Trt-Eval Interval | PRECOUNT | PRECOUNT | 2 DA-A | 2 DA-A | 7 DA-A | 7 DA-A |
| MEAN COUNTS | | | | | | |
| Sample A | 5.5 | 0 | 5.5 | 0 | 1 | 4 |
| Untreated Check | 5 | 0 | 6.25 | 0 | 15.5 | 0.5 |

### Test System 4—Efficacy Screen—Silverleaf Whitefly

Objective: Efficacy screen of SAMPLE A against silverleaf whitefly on poinsettia.

Procedure: Test plants, Poinsettia, Euphorbia pulcherrima, were planted into 1-quart containers in a growing medium consisting of 35% peat, 45% aged pine bark, 15% aged rice hulls and 5% composted hardwood. No pesticides were applied to test plants prior to study application. One plant equals one replicate. Test plants were placed in Zone 3 of research greenhouse on a wire-mesh raised bench and arranged in a randomized complete block design. Research greenhouse is monitored by Procom, Micro-Grow Greenhouse System temperature control system. Environmental conditions averaged high temperature 87 F to low temperature of 72 F during study dates. Average humidity levels ranged form 40% to 100%. Test plants received natural lighting for duration of study. Test plants were watered every twenty-four (24) hours as needed with a hand-held sprinkler. Plants were evaluated prior to application (precount), 2 days (48 hours) and 7 days after application. Four (4) leaves were randomly selected on each replicate; ¾″ plug was cut from each leaf. Actual count was recorded on silverleaf whitefly, Bemisia argentifolii, live nymph, dead nymph, live pupa, and dead pupa. Plants were evaluated for phytotoxicity on same rating schedule as above. Visual ratings were taken and recorded as percent of damage (0 to 100%) to whole plant as compared to control check.

Treatment: Treatment #1—Sample A 0.6% oxymatrine @ 1 ml/800 ml, and Treatment #2—Untreated Check. Spray application was made.

Conclusion: Evaluations of Silverleaf Whitefly at 7 days after chemical application did show a significant decrease in the number of live nymph in Treatment #1, Sample A, as compared to number of live nymph in Treatment #2, Untreated Check. There was no phytotoxicity on any treated plant.

### Test System 5—Efficacy Screen—Cockroach

Procedure: Cockroaches, Blatella germanica, were immobilized by using CO₂ for approximately 20 seconds. Five (5) adult cockroaches were placed in a 1.89 liter test container. One container equals one replicate. Lid of each container has a 2″×4″ insert of screening. A moist cotton ball was placed in each container as water source. Cockroaches were allowed to recover for approximately 30 minutes before treatment application was performed. Test containers were placed in research laboratory in a randomized complete block design. Evaluation was made on live, knockdown and dead cockroaches at 1 hour, 24 hour and 48 hour intervals after treatment application.

Treatment: Treatment #1—Sample A 0.6% oxymatrine @ 1 ml/500 ml, and Treatment #2—Untreated Check. Spray application was made. Using a hand sprayer approximately 10 ml (2 grams) was dispersed into each treated replicate.

Conclusion: Evaluations of German cockroach at 48 hours after chemical application did show 45% mortality in Treatment #1, Sample A as compared to 15% mortality in Treatment #2, Untreated Check.

### Test System 6—Efficacy Screen—Corn Rootworm Beetle

Procedure: Twenty (20) corn rootworm beetles, Diabrotica virgifera, were placed in a 1.89 liter test container. One container equals one replicate. Lid of each container has a 2″×4″ insert of screening. A section of corn leaf was placed in each replicate as food source. Test containers were placed in research laboratory in a randomized complete block design. Evaluation was made on live, knockdown and dead corn rootworm beetles at 1 hour, 24 hour and 48 hour intervals after treatment application.

Treatment: Treatment #1—Sample A 0.6% oxymatrine @ 1 ml/500 ml, and Treatment #2—Untreated Check. Spray application was made. Using a hand sprayer approximately 10 ml (2 grams) was dispersed into each treated replicate.

Conclusion: Evaluation of Corn Rootworm Beetle at 48 hours after chemical application did show 85% mortality in Treatment #1, Sample A as compared to 0.4% mortality in Treatment #2, Untreated Check.

### Test System 7—Efficacy Screen—Armyworm

Procedure: Field corn, Zeamx mays l. was seeded into 3.5″×3.5″ containers in a growing medium consisting of 35% peat, 45% aged pine bark, 15% aged rice hulls and 5% composted hardwood. One container equals one replicate. Test plants were placed in Zone 2 of research greenhouse on a wire-mesh raised bench and arranged in a randomized complete block design. Research greenhouse is monitored by Procom, Micro-Grow Greenhouse System temperature control system. Environmental conditions averaged high temperature 82 F to low temperature of 70 F during study dates. Average humidity levels ranged form 40% to 95%. Test plants received natural lighting for duration of study. Test plants were watered every twenty-four (24) hours as needed with a hand-held sprinkler. Corn plants were artificially infested with five (5) armyworm, Pseudaletia unipuncta, 1^{st} instar larva. Larva was placed in leaf rolls of each replicate. After infesting each replicate was placed on a drip plate for watering purposes. Overhead irrigation was not utilized after infestation. Plants were evaluated 48 hours after chemical application. Damage caused by insect/pest feeding was rated as percent damage to whole plant. Insect/pest was evaluated 48 hours after chemical application. Plants were dissected; actual count was recorded on live armyworm. Plants were evaluated for phytotoxicity on same rating schedule as above. Visual ratings were taken and recorded as percent of damage (0 to 100%) to whole plant as compared to control check.

Treatment: Treatment #1—Sample A 0.6% oxymatrine @ 1 ml/500 ml, and Treatment #2—Untreated Check. Spray application was made.

Conclusion: Treatment #1, SAMPLE A did provide a moderate degree of control on test insect, Pseudaletia unipuncta.

TABLE VII

| | Insect | | |
|---|---|---|---|
| | Armyworm/Pseudaletia Unipuncta | | |
| | Crop | | |
| | Field Corn/Zeamx Mays L. | | |
| Part Rated | Crop | Crop | Pest |
| Rating Data | insect/pest damage; | | Insect |
| Type | feeding injury | | Count |
| Rating Unit | 0-100 | 0-100 | ACTUAL |
| Rating Date | Day 2 | Day 2 | Day 2 |
| Insect Stage | | | LIVE |
| Trt-Eval | 48 HOURS | 48 HOURS | 48 HOURS |
| Interval | | | |
| MEAN | | | |
| COUNTS | | | |
| Sample A | 0 | 3.75 | 1 |
| Untreated | 0 | 10 | 2.5 |
| Check | | | |

### Test System 8—Efficacy Screen—Tobacco Budworm

Procedure: Field corn, Zeamx mays l. was seeded into 3.5″×3.5″ containers in a growing medium consisting of 35% peat, 45% aged pine bark, 15% aged rice hulls and 5% composted hardwood. One container equals one replicate. Test plants were placed in Zone 2 of research greenhouse on a wire-mesh raised bench and arranged in a randomized complete block design. Research greenhouse is monitored by Procom, Micro-Grow Greenhouse System temperature control system. Environmental conditions averaged high temperature 82 F to low temperature of 70 F during study dates. Average humidity levels ranged form 40% to 95%. Test plants received natural lighting for duration of study. Test plants were watered every twenty-four (24) hours as needed with a hand-held sprinkler. Corn plants were artificially infested with five (5) tobacco budworm, Heliothis virescent, 1^{st} instar larva. Larva was placed in leaf rolls of each replicate. After infesting each replicate was placed on a drip plate for watering purposes. Overhead irrigation was not utilized after infestation. Plants were evaluated 48 hours after chemical application. Damage caused by insect/pest feeding was rated as percent damage to whole plant. Insect/pest was evaluated 48 hours after chemical application. Plants were dissected; actual count was recorded on live armyworm. Plants were evaluated for phytotoxicity on same rating schedule as above. Visual ratings were taken and recorded as percent of damage (0 to 100%) to whole plant as compared to control check.

Treatment: Treatment #1—Sample A 0.6% oxymatrine @ 1 ml/500 ml, and Treatment #2—Untreated Check. Spray application was made.

Conclusion: Treatment #1, SAMPLE A did provide a good degree of control on test insect, Heliothis virescent.

TABLE VIII

| | Insect | | |
|---|---|---|---|
| | tobacco budworm/Heliothis | | |
| | virescant (Fabricius) | | |
| | Crop | | |
| | Field Corn/Zeamx Mays L. | | |
| Part Rated | Crop | Crop | Pest |
| Rating Data | insect/pest damage; | | Insect |
| Type | feeding injury | | Count |
| Rating Unit | 0-100% | 0-100% | ACTUAL |
| Rating Date | Day 2 | Day 2 | Day 2 |
| Insect Stage | | | LIVE |
| Trt-Eval | 48 HOURS | 48 HOURS | 48 HOURS |
| Interval | | | |
| MEAN | | | |
| COUNTS | | | |
| Sample A | 0 | 2 | 0 |
| Untreated | 0 | 4.5 | 2.25 |
| Check | | | |

Contact Study of MOI 201 on Armyworms (Spodoptera exigua)

Objective: Observe the mode of action and the symptoms caused by 0.6% oxymatrine on larvae of armyworms, as well as to quantify the time required for the larvae to become paralyzed or dead.

Method: Larvae of beet armyworm were taken as first In-star stage and placed on a microscope slide under a stereomicroscope. A drop of the test product was delivered over them and the larvae were left to soak for 30 seconds. Excess liquid was absorbed with a paper towel and the larvae were observed under the microscope. The products tested were Spinosad at 0.3%, Permethrin at 1%, and 0.6% oxymatrine at 800× and 1000× dilutions. Time 1 indicates the time it took before the larva was unable to perform normal activities like crawling, feeding, etc. Time 2 is the additional time needed for complete elimination/death.

Contact study of Army worm first in star with 0.6% oxymatrine

| Product | Rep | Time 1 (min) | | | Time 2 (min) | | |
|---|---|---|---|---|---|---|---|
| Spinosad | 1 | 7.58 | Average | 6.99 | 146 | Average | 289.00 |
| | 2 | 8.46 | STDEV | 1.00 | 180 | STDEV | 115.86 |
| | 3 | 6.33 | | | 363 | | |
| | 4 | 6.4 | | | 373 | | |
| | 5 | 6.17 | | | 383 | | |
| Permethrin | 1 | 1.15 | Average | 1.22 | 97 | Average | 333.60 |
| | 2 | 1.19 | STDEV | 0.19 | 299 | STDEV | 144.02 |
| | 3 | 1.56 | | | 447 | | |
| | 4 | 1.09 | | | 428 | | |
| | 5 | 1.11 | | | 397 | | |
| MOI 201 | 1 | 9.03 | Average | 14.01 | 126 | Average | 350.00 |
| 800x | | | | | | | |
| | 2 | 18.21 | STDEV | 5.85 | 146 | STDEV | 449.53 |
| | 3 | 21.09 | | | 122 | | |
| | 4 | 7.36 | | | 204 | | |
| | 5 | 14.35 | | | 1152 | | |
| MOI 201 | 1 | 10.31 | Average | 13.99 | 426 | Average | 392.00 |
| 1000x | | | | | | | |
| | 2 | 15.36 | STDEV | 5.34 | 440 | STDEV | 66.73 |
| | 3 | 8.21 | | | 384 | | |
| | 4 | 22.06 | | | 431 | | |
| | 5 | 14 | | | 279 | | |

Time 1: time (min) required for paralysis or convulsions
Time 2: time (min) between paralysis and death

### Results:

Spinosad, Permethrin, and 0.6% oxymatrine all work as contact insecticides with different modes of action.
Permethrin affected the insect's basic functions in a shorter period of time (1.2 min) than Spinosad (7.0 min) and 0.6% oxymatrine (14.0 min).
There were no significant differences between the two dilution rates of 0.6% oxymatrine.

Although this invention has been described with reference to specific embodiments, the details thereof are not to be construed as limiting, as it is obvious that one can use various equivalents, changes and modifications and still be within the scope of the present invention.

Various references are cited throughout this specification, each of which is incorporated herein by reference in its entirety.

### REFERENCES

Thacker J M R. 2002. An Introduction to Arthropod Pest Control. Cambridge, UK: Cambridge Univ. Press., chapter 2
Murray B. Isman. 2006. Botanical Insecticides, Deterrents, and Repellents in Modern Agriculture and an increasingly regulated world. Annual. Rev. Entomol. 51:45-66.
Schmutterer H, ed. 2002. The Neem Tree. Mumbai: Neem Found.,
Roy A. 2006. Limonoids: Overview of Significant Bioactive Triterpenes Distributed in Plants Kingdom. Biol. Pharm. Bull. 29(2) 191-201.
Hollingworth R, Ahmmadsahib K, Gedelhak G, McLaughlin J. 1994. New inhibitors of complex I of the mitochondrial electron transport chain with activity as pesticides. Biochem. Soc. Trans. 22:230-33.
Niu Kuizhi, Pharmacology and clinical application of sophora flavescentis, International Journal of Oriental Medicine 1997; 22(1): 75-81.
Wu, Chang-An, Hong Wu, and Ling Lei. U.S. Pat. No. 6,372,239. Compositions and methods for controlling pests using synergistic cocktails of plant alkaloids. Apr. 16, 2002.

What is claimed is:

1. A water-soluble insecticidal or pesticidal formulation, comprising an insecticidally or pesticidally effective amount of at least one tetracyclo-quinolizinindine alkaloid derived from sophora roots.

2. The formulation of claim 1 wherein said tetracycloquinolizinindine alkaloid is oxymatrine or matrine.

3. The formulation of claim 1 wherein formulation comprises two tetracyclo-quinolizinindine alkaloid derived from sophora roots, wherein said tetracyclo-quinolizinindine alkaloids are oxymatrine and matrine.

4. The formulation of claim 1, further comprising water, wherein the amount of oxymatrine or matrine in said formulation is in the range of from about 0.1% to 20% by volume.

5. The formulation of claim 1, further comprising one or more surfactants, dispersants and/or wetting agents.

6. The composition of claim 1 further comprising a non-oxymatrine, matrine, anabasine, aloperine and/or toosendanin pesticide or insecticide.

7. A method for protecting or treating plants and fruit from insect and mite infestations comprising applying an effective amount of the formulation of claim 1.

8. A method for protecting or treating buildings or other structures from insects by applying an effective amount of the formulation of claim 1.

9. A water-soluble anabasine, aloperine and/or toosendanin free insecticidal or pesticidal formulation, comprising an insecticidally or pesticidally effective amount of oxymatrine and/or matrine.

10. Use of at least one tetracyclo-quinolizinindine alkaloid derived from sophora rootsoxymatrine or matrine in the preparation of an insecticidal or pesticidal formulation.
